(19) United States
(12) Patent Application Publication
(10) Pub. No.: US 2014/0286321 A1
(43) Pub. Date: Sep. 25, 2014

(54) METHOD OF ASSOCIATING A CLIENT WITH AN ACCESS POINT IN A WIRELESS LOCAL AREA NETWORK

(71) Applicants: John S. Balian, Westford, MA (US); Richard S. Davis, Salem, MA (US); Sung-Ju Lee, Redwood City, CA (US); Vincent Ma, Shrewsbury, MA (US)

(72) Inventors: John S. Balian, Westford, MA (US); Richard S. Davis, Salem, MA (US); Sung-Ju Lee, Redwood City, CA (US); Vincent Ma, Shrewsbury, MA (US)

(73) Assignee: Hewlett-Packard Development Company, L.P., Houston, TX (US)

(21) Appl. No.: 14/114,453

(22) PCT Filed: Jun. 28, 2011
(86) PCT No.: PCT/US2011/042202

§ 371 Date: Mar. 28, 2014

(51) Int. Cl. H04W 48/16; H04W 84/12

(52) U.S. Cl. CPC H04W 48/16; H04W 84/12
USPC 370/338

(57) ABSTRACT

A method of associating a client with an access point in a wireless local area network. The access point broadcasts a beacon announcing the existence of the access point. The beacon comprises a field which has a list of client identifiers of acceptable clients from which the access point will accept an association request.

### BACKGROUND OF THE DISCLOSURE

A wireless local area network (WLAN) allows client devices to communicate with each other and/or to share data wirelessly. A typical WLAN comprises an access point (AP) which manages communication in the wireless network. The access point may also allow devices connected to the WLAN to connect to wired devices or to a wired network which may be connected to the access point.

In one common method, the access point broadcasts a beacon announcing its existence to potential client devices. Upon detecting a beacon from an access point, a client device decides whether or not to associate with the access point. If the client device detects several beacons it may make a choice based on various criteria, one of the most common criteria is the strength of the beacon signal.

### BRIEF DESCRIPTION OF THE DRAWINGS

Some examples are described in the following figures, in which:

FIG. 1 shows one example of a WLAN having an access point;

FIG. 2 shows one example of a method of associating a client device with an access point;

FIG. 3 shows one example of a beacon comprising a list of identifiers of client devices;

FIG. 4 shows one example of a MAC address;

FIG. 5 shows a more detailed example of a beacon comprising a list of identifiers of client devices;

FIG. 6 is a flow diagram showing an example of processes carried out by the AP of FIG. 1; and

FIG. 7 is a flow diagram showing an example of processes carried out by the client device of FIG. 1.

### DETAILED DESCRIPTION

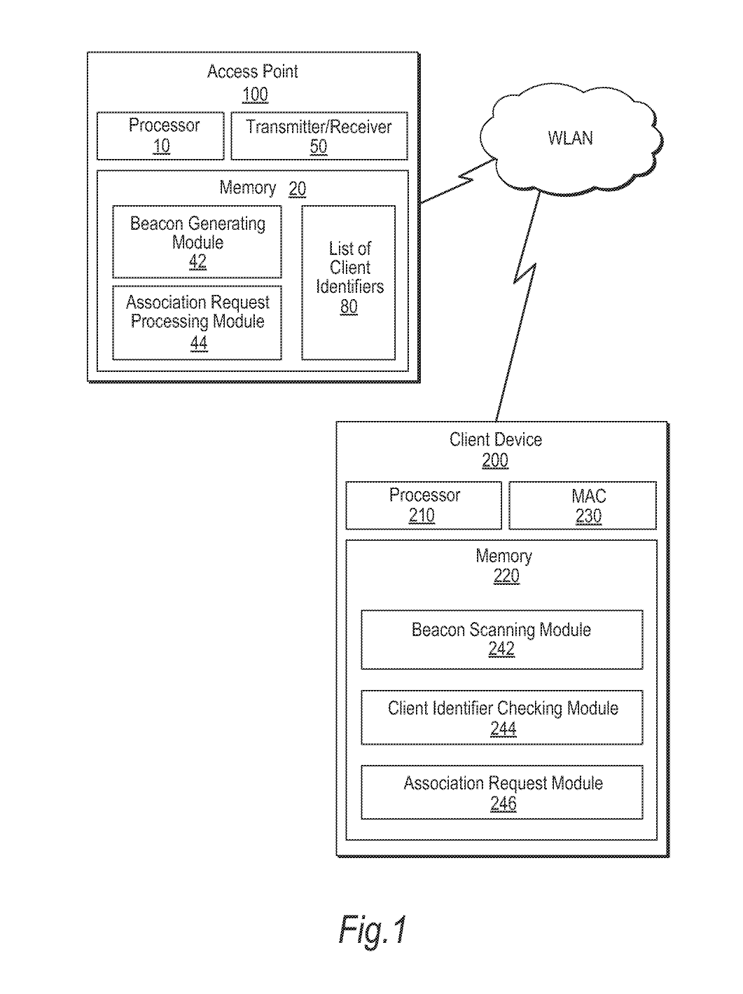

FIG. 1 shows an example of a wireless local area network (WLAN) comprising an access point 100 and a plurality of client devices 200. A client device is any device which is able to connect to a WLAN and use the protocols of the WLAN. For example a client device may be a user device such as a mobile phone, a desktop or laptop computer or a printer, or a non-user type device such as a wireless sensor.

The access point (AP) 100 may facilitate communication between client devices connected to the WLAN. The access point may be connected to a wired device, or to another (wired or wireless) network, in which case the access point facilitates communication between the client devices of the WLAN and the wired device or another network. In some cases the access point may be connected to, or may comprise, a router which enables client devices of the WLAN to connect to the internet.

The access point 100 comprises a processor 10 and a memory 20. The memory 20 stores a list of identifiers 30 of pre-assigned client devices with which the access point may associate. By pre-assigned it is meant that the client device identifiers are stored in the memory of the access point before the client devices wirelessly connect to the access point (e.g. before the WLAN is set up). The client identifiers may be MAC addresses of the client devices. In one example the client identifiers are the MAC addresses of the client devices minus the manufacturer identifying portion of the MAC address (e.g. excluding the first 3 bytes of the MAC address which correspond to the Organizationally Unique Identifier).

The access point 100 is pre-configured to accept association requests from the client devices whose identifiers are stored in the list 30. This has the advantage that little processing power and time is consumed by the access point when processing an association request from a client device.

The memory 20 stores a set of machine readable instructions executable by the processor 10. The machine readable instructions comprise a module 42 to generate a beacon and a module 44 to process association requests from client devices. The module 42 generates a beacon which announces the existence of the access point to potential clients and is transmitted wirelessly via transmitter 50. The beacon may be a beacon in accordance with the IEEE 802.11 standard. The module 42 adds a ‘client list’ field to the beacon. The client list field of the beacon comprises the client identifiers which are stored in the list 30.

There may be hundreds of client devices or nodes, but just one is shown in detail in the example of FIG. 1. The client device 200 shown in FIG. 1 has a processor 210, a memory 220 storing machine readable instructions which are executable by the processor, a transmitter and receiver 250 and a MAC address 230 which may for instance be stored in read only memory of the client device. The client device 200 scans for beacons sent by access points and upon receiving a beacon, the client device checks if its MAC address matches a client identifier in the ‘client list’ field of the beacon. If it matches then the client device 200 sends an association request to the access point. This has the advantage that the client device does not need to carry out a complicated decision process in order to decide which access point to associate with. This can save time and power, which can be important on battery operated devices.

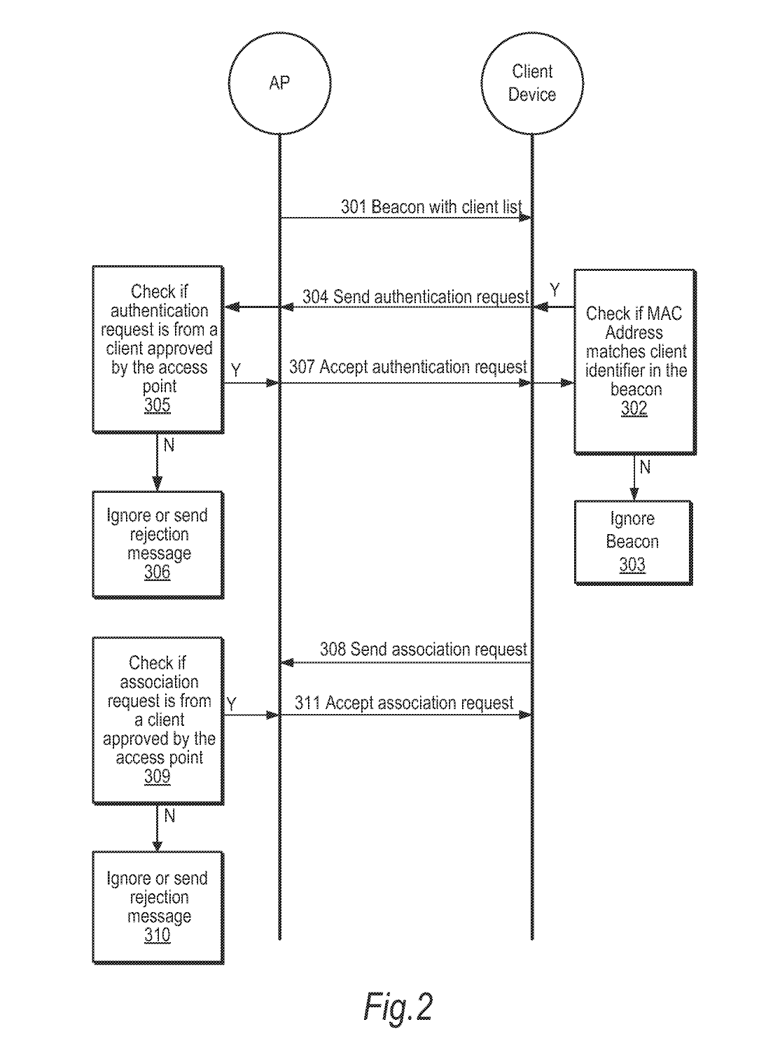

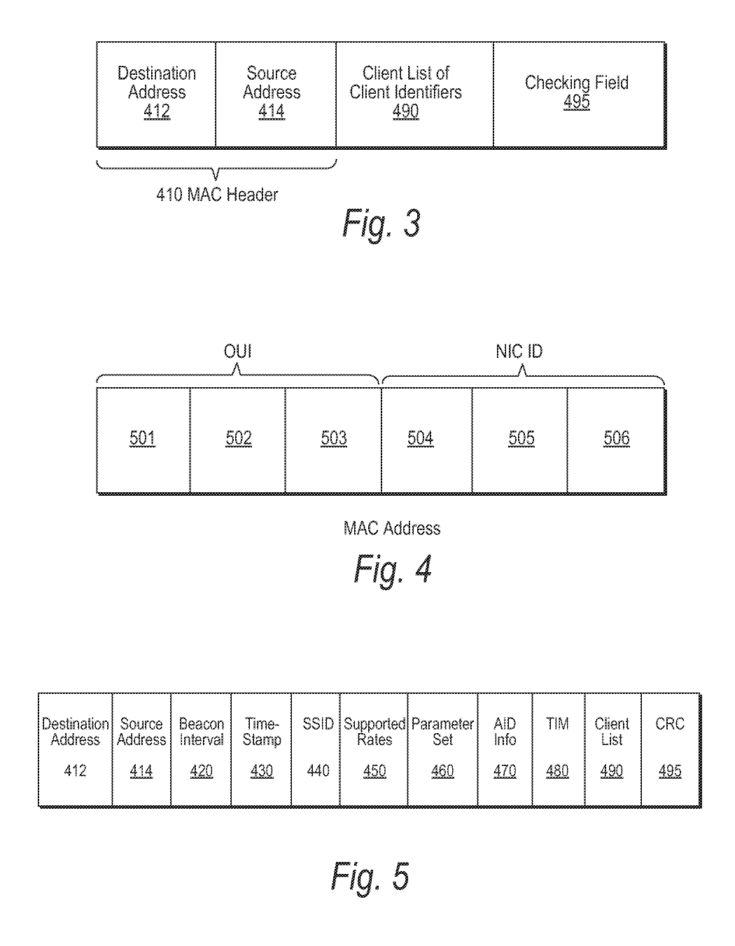

FIG. 2 is a flow diagram showing the process in detail. At 301 the access point (AP) 100 sends a beacon with a field indicating the client devices which are pre-assigned to the access point. An example of a beacon 400 is shown in FIGS. 3 and 4 and explained in more detail later. The beacon comprises a list of client identifiers from which the AP will accept association requests. At 302 a client device receives the beacon and checks the list of client identifiers in the beacon to determine if the MAC address of the client device matches a client identifier in the list. If the client device's MAC address does not match, then the client device ignores the beacon at 303 (as it is not pre-assigned to that AP). If the client device MAC address matches a client identifier in the client list in the beacon, then the client devices sends an authentication request to the AP at 304. At 305 the AP receives the authentication request and checks that the authentication request was sent by a client device on its list of pre-assigned/acceptable client devices (e.g. it may check by comparing the source address of the authentication request with the client identifiers in the list 30 in memory 20).

If the AP determines that the MAC address of the client device matches a client identifier in the list of approved client devices, then the AP ignores the authentication request or sends a rejection message to the client device at 306. If the AP determines that the authentication request was sent by a client device not on the list 30, then the AP ignores the authentication request or alternatively may send a rejection message to the client device (306). This may happen, for instance, if a conventional client device which is not intended for the WLAN detects the beacon and sends an authentication request (based on a signal strength algorithm for instance).

If the AP determines that the MAC address of the client device matches a client identifier in the list of approved client devices then the AP approves the authentication request and sends a successful authentication response to the client device at 307. The client device has now been authenticated by the AP.

The client device proceeds to send an association request to the AP at 308. At 309 the AP receives the association request and checks if the association request was sent by a client device which is on the list 30 of approved (e.g. pre-assigned) client devices for that AP. If the association request was not sent by an approved client device then the AP ignores the association request or sends a rejection message to the client device at 310. If the association request was sent by a client device on the approved list of client devices, then the AP accepts the association request and sends an acceptance message to the client device at 311. The client device is now associated with the AP and may access resources on the WLAN.

While in the above example the AP checked if the client device had a MAC address matching a client identifier in the list 30 of approved clients at both the authentication and association stages, it would be possible for the check to be made at only one of the stages. E.g. either steps 306 and 307 or steps 309 and 310 could be left out. In one example, the AP authenticates clients responding to the beacon without checking the client list, but checks the client list 30 before responding to an association request and only accepts the association request if the client device has a MAC address matching the client identifier in the list 30. Note that in this example, the access point checking the MAC address of the client device at step 305 and/or 309 is carried out before the client device is allowed to associate with the access point. This is separate to any checking of the MAC address after the client has associated with the access point and before it is allowed to access resources on the network (which may be required in some networks).

The method described in FIG. 2 has the advantage that the client device does not need to perform a complicated process for determining which access point to send an association request to. For example, the client device need not compare the signal strength from several different access points in order to make a decision, but can simply check if the beacon has a client identifier matching the MAC address of the client device. Further, user input is not necessary in order to select which access point to associate with.

The method, apparatus and techniques described in this disclosure may be applied to any type of WLAN clients and access points. One scenario in which it may be particularly advantageous is where one or more clients have a fixed location, as each fixed location client may then be usefully be pre-assigned to an access point based on a radio frequency survey, although the disclosure is not limited to this scenario. While applicable to any type of client devices, the disclosure may be particularly useful for client devices which are not user devices and/or client devices which have low processing power or limited power resources (e.g. battery), as in some embodiments user input is not needed to associate with an access point and the processing and power demands on the client device for choosing and associating with an access point may be kept relatively modest.

In one example the client device is a sensor (in this disclosure a “sensor” refers to a device which has the primary function of sensing or measuring a parameter (e.g. temperature, humidity, presence of chemicals, intensity of light etc) and communicating the result of the measurement, but does not have a keyboard or similar user interface. In one example, the client devices are sensors used on an oil rig. The oil rig may have a plurality of access points and client devices (e.g. sensors).

The placing of the client devices and access points may be planned in advance by carrying out a radio frequency survey. Each client device may be pre-assigned to an access point based on the radio frequency survey and/or other considerations. Each access point is then given a list of pre-assigned client devices which it is pre-assigned and a list of client identifiers stored in the access point's memory. This approach is relatively efficient as while the access point needs to store the client device identifiers, the individual client devices (of which there may be a large number) do not require detailed pre-configuration. Each client device knows its own MAC address and can thus find an access point to which it has been pre-assigned by scanning for beacons containing a matching client identifier, without knowing the SSID or access point address in advance.

FIG. 3 shows an example of a beacon. It comprises a MAC header 410, a list 490 of client identifiers of pre-assigned clients from which the AP will accept an association request and a checking field 495 for checking the integrity of data in the beacon (e.g. a CRC or cyclic redundancy checking field). The MAC header comprises a broadcast address (e.g. FF:FF:FF:FF:FF:FF) set as the destination address 412 and the MAC address of the AP as the source address 414. In networking the broadcast address is conventionally an address which is used to indicate that the frame should be broadcast to every device on the network.

In one example the client identifiers in the client list section of the beacon are full MAC addresses of the client devices. In another example the client identifiers are MAC addresses excluding the manufacturer identifying portion. FIG. 4 shows a typical MAC address in which the first three bytes 501, 502, 503 identify the manufacturer (i.e. the ‘manufacturer identifying portion’, sometimes known as the Organizationally Unique Identifier or OUI). The last three bytes in the MAC address shown in FIG. 4 identify the device uniquely, compared to other devices from that manufacturer, and are sometimes referred to as the NIC ID (network interface card identity). If all the client devices pre-assigned to the access point are from the same manufacturer, then even if the MAC addresses in the client list of the beacon exclude the OUI, each device will still be uniquely identified in the context of the network.

The list of MAC addresses 30 of pre-assigned clients stored in the memory 20 of the access point may exclude the OUI. However, for extra security the MAC addresses in the list in memory may include the OUI so that any requests from client devices which happen to have the same NIC ID but are from a different manufacturer and not pre-assigned to the network, may be securely rejected. In one example the MAC addresses in the list in memory includes the OUI, while the MAC addresses in the client list in the beacon do not include the OUI; this makes the transmission more compact.

FIG. 5 shows a further example of a beacon. It comprises a MAC header 410 as described above, an interval section 420 which indicates the time interval at which the beacon is broadcast. A timestamp section 430 indicating the time at which the beacon was broadcast. A SSID section 440 indicating the SSID (i.e. the WLAN ID). Sections with information relating to supported data transmission rates 450, a parameter set of the access point 460, and further information about the AP 470. There may also be a traffic indication map (TIM) 480 indicating the association ID's (AIDs) of client devices which are in power saving mode and which have a data frame waiting for them in a buffer of the access point. An AID is not uniquely tied to a client device, but rather is assigned dynamically on completion of a successful association request. As such, an AID can only identify a client which has already joined the WLAN and cannot identify a pre-assigned client device before an association request has been made and accepted. The beacon shown in FIG. 5 further comprises a client list section 490 with client identifiers of all pre-assigned client devices from which the access point will accept an association request and a Cyclic Redundancy Checking section 495.

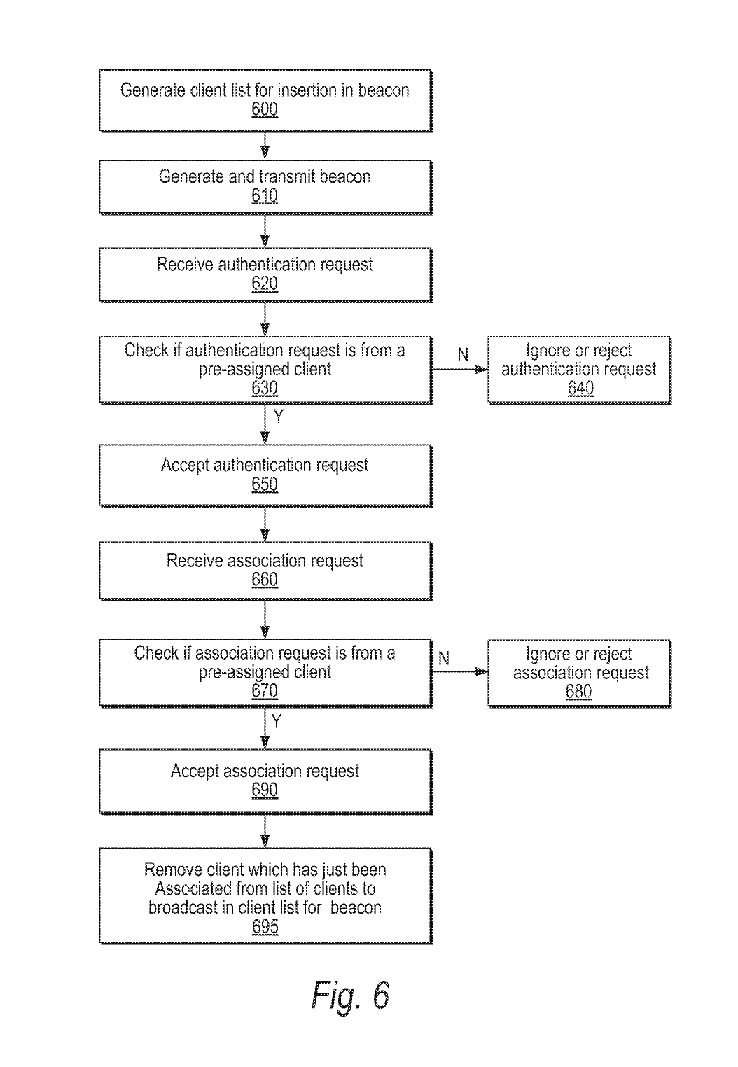

FIG. 6 is a flow diagram showing an example of processes carried out by the access point. At 600 the access point generates a list of identifiers of pre-assigned client devices to include in the client list section of the beacon. The list may be the same as or based upon the list 20 held in the memory 30. At 610 the access point generates and transmits a beacon including a client list section. At 620 the access point receives an authentication request from a client device. At 630 the access point checks if the client device has a MAC address matching a client identifier in the pre-assigned client list 20 held in memory 30. If not then at 640 the access point either ignores the authentication request or sends back a message indicating that the request is rejected. If the MAC address does match then at 650 the access point accepts the authentication request and sends an acceptance message. At 660 the access point receives an association request from the authenticated client device. At 670 the access point checks if the client device has a MAC address matching a client identifier in the pre-assigned client list 20 held in memory 30. If not then at 680 the access point either ignores the association request or sends back a message indicating that the request is rejected. If the MAC address does match then at 690 the access point accepts the association request. The access point may transmit a message to the client device indicating that the association request has been accepted. The message may include an association ID (AID) for the association with the client device. While in the above example, the access point checks if the client device is on the list 30 of pre-assigned clients at both the authentication and association stages, in alternative embodiments the check may be made at only one of these stages. E.g. in one alternative example, steps 630 and 640 are eliminated so that the access point accepts an authentication request without checking the list of pre-assigned clients and then checks the list of pre-assigned clients before approving an association request.

The processes described in 610 may continue indefinitely with the beacon being transmitted periodically, while the processes described in 620 to 680 may occur each time authentication and association requests are received. The access point may continue sending beacons with a complete list of client devices to which it has been pre-assigned. Alternatively, after a client device has successfully associated with the access point (e.g. at 690), future beacons from the access point may omit clients which have already associated from the client list. An example is shown at 695, where after a client has associated with the access point the access point removes the client from a list of clients to be included in the beacon's client list. The access point will still store the client identifier (e.g. MAC address) of the associated client in memory, but may refrain from broadcasting the client identifier in the beacon after the client has successfully associated. The advantage of this is that the size of the beacon is reduced. If a successfully associated client subsequently disconnects from the network, the access point may add the client identifier back to the client list in the beacon so that the client may reconnect. The method described in FIG. 6 may be stored as machine readable instructions on a memory and executed by the processor of the access point. For instance processes 600 to 610 and 695 may be carried out by the beacon generating module 42 shown in FIG. 1, while processes 620 to 690 may be carried out by the association request processing module 44 shown in FIG. 1.

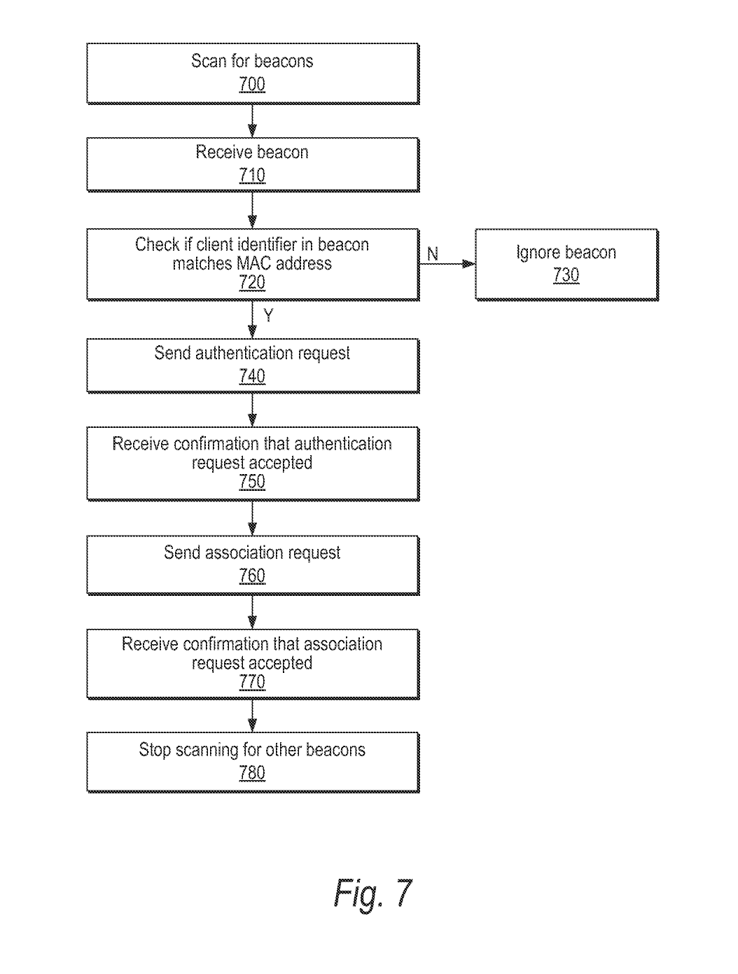

FIG. 7 is a flow diagram showing an example of processes carried out by a client device. At 700 the client device scans for beacons broadcast by access points. At 710 the client device receives a beacon which has been broadcast by an access point. At 720 the client device checks the received beacon to determine if beacon has a client list having a client identifier matching the MAC address of the client device. If not then at 730 the client device ignores the beacon. If there is a match, then at 740 the client device wirelessly transmits an authentication request to the access point which sent the beacon. At 750 the client device receives confirmation from the access point that the authentication request has been accepted. The client device then proceeds to wirelessly transmit an association request to the access point at 760. At 770 the client device receives confirmation from the access point that the association request has been accepted. The confirmation message may include an association ID (AID) for the association of the client device with the access point. At 780, once the association with the access point has been completed, the client device stops scanning for further beacons in order to conserve power and processing resources (e.g. for instance the client device may continue to receive beacons from the associated access point, but stop scanning for beacons from other access points on different channels). The method described in FIG. 7 may be stored as machine readable instructions on a memory and executed by the processor of the client device. For example, with reference to the modules of machine readable instructions stored in memory 220 of the client device shown in FIG. 1, processes 700 and 710 may be carried out by beacon scanning module 242, while processes 720 and 730 may be carried out by a client identifier checking module 244 and processes 740-780 may be carried out by an association request module 246.

The methods described herein may be loaded for execution on a processor, e.g. the processor 10 of the access point or the processor 210 of the client device as shown in FIG. 1. The term ‘processor’ as used in this disclosure includes, but is not limited to, microprocessors, microcontrollers, processor modules or subsystems (including one or more microprocessors or microcontrollers), controllers, ASICs, analog or digital circuits, programmed logic devices etc. As used here, a “processor” can refer to a single component or to plural components. The various methods and processes described herein may be stored in a memory as machine readable instructions and executable on the processor. The memory may be any form of memory, including but not limited to, semiconductor memory devices such as dynamic or static random access memories (DRAMs or SRAMs), erasable and programmable read-only memories (EPROMs), electrically erasable and programmable read-only memories (EEPROMs) and flash memories and magnetic disks. The memory may be a single storage medium or distributed on multiple storage media. The combination of a “processor” and “machine readable instructions stored on a memory” described in this disclosure includes combined approaches such as a logic circuit, ASIC, or integrated circuit hardwired to carry out the above mentioned methods, as well as implementations with a separate memory and processor

What is claimed is:

1. An access point having a transmitter, a processor and a memory storing a list of identifiers of pre-assigned clients from which the access point will accept an association request and machine readable instructions executable by the processor to transmit a beacon announcing the existence of the access point, said beacon including a client list section comprising identifiers of said pre-assigned clients.

2. The access point of claim 1 wherein the identifiers of pre-assigned clients stored in said memory and in the client list section of the beacon are MAC addresses of said pre-assigned clients.

3. The access point of claim 2 wherein the MAC addresses in the client list section of the beacon do not include the manufacturer identifying portion of the MAC addresses.

4. The access point of claim 1 wherein the beacon is a beacon in accordance with the IEEE 802.11 standard.

5. The access point of claim 1 wherein the machine readable instructions comprise instructions to generate a beacon comprising a MAC header having the broadcast domain as the destination address, a client list section comprising a list of identifiers of clients which the access point will associate with and a checking section.

6. The access point of claim 1 wherein the machine readable instructions further comprise instructions to examine an association request received from a client and accept said association request if the access point determines that the association request was sent from a client identified on said list of pre-assigned clients.

7. The access point of claim 6 wherein the machine readable instructions further comprise instructions for removing a client's client identifier from the client list section of subsequent beacon broadcasts after said client has successfully associated with the access point.

8. The access point of claim 7 wherein the machine readable instructions comprise instructions to add a client identifier back to the client list of beacon broadcasts if the client associated with said client identifier disconnects from the WLAN.

9. The access point of claim 1 wherein the machine readable instructions executable comprise instructions to examine an authentication request received from a client and accept said authentication request if the access point determines that the authentication request was sent from a client identified on said list of pre-assigned clients.

10. A client device having a MAC address, a receiver, a processor and a memory storing machine readable instructions executable by the processor to scan for beacons announcing the existence of an access point, check any beacons received by the receiver to determine if the beacon contains a client identifier matching said client device's MAC address and if a beacon does contain a client identifier matching the client device's MAC address then send an association request to the access point which sent said beacon.

11. The client device of claim 10 wherein the machine readable instructions comprise instructions to examine a client list section of a beacon received by the client device and check if a client identifier matching the client device's MAC address is in the client list section.

12. The client device of claim 10, wherein the client device is a sensor.

13. The client device of claim 10 wherein a client identifier in the beacon is considered to match the client device's MAC address if it comprises the non manufacturer-specific portion of the client device's MAC address.

14. The client device of claim 10 wherein the client device is configured to ignore a beacon which does not contain a client identifier matching the client device's MAC address.

15. The client device of claim 10 wherein the machine readable instructions include instructions to stop scanning for beacons from other access points, once the client device has successfully associated with a first access point.

16. A method of associating client nodes with an access point in a wireless local area network, said method comprising:
a) an access point broadcasting a beacon announcing the existence of the access point, the beacon comprising a field which has a list of client identifiers of acceptable client nodes from which the access point will accept an association request.

17. The method of claim 16 further comprising the access point receiving an association request from a client node, examining the association request to check that said client node is included on a list of acceptable client nodes for said access point and accepting said association request if the access point determines that the client node is included on said list.

18. The method of claim 16 further comprising a client node receiving said beacon and checking if the client node's MAC address matches one of the client identifiers in said list in the beacon.

19. The method of claim 16 further comprising the client node determining that its MAC address matches one of the client identifiers in the beacon and the client node sending an association request to the access point.

20. The method of claim 16 wherein the client identifiers in the beacon are MAC addresses.
